(19) United States
(12) Patent Application Publication
(10) Pub. No.: US 2005/0278250 A1
(43) Pub. Date: Dec. 15, 2005

(54) Transaction processing payment system

(76) Inventor: Kays Zair, Southfield, MI (US)

Correspondence Address: DICKINSON WRIGHT PLLC, 1901 L. STREET NW, SUITE 800, WASHINGTON, DC, 20036, US

(21) Appl. No.: 10/864,370

(22) Filed: Jun. 10, 2004

(51) Int. Cl. G06F 17/60

(52) U.S. Cl. 705/39

(57) ABSTRACT

A computerized financial transaction system encompasses payment of a bill by a customer at an agent site, where the agent accepts funds in payment of the bill, and enters or scans customer and payment information directly on a host provider's website. The host provider processes the payment information and formats the payment information into an acceptable format for electronic notification to the creditor. The host provider forwards payment to the creditor according to the creditor's protocol, and debits the agent's bank account for reimbursement of the funds paid to the creditor on behalf of the customer, as well as for a service fee for the payment service.

The present invention relates to a computerized transaction processing system for facilitating bill payment to a creditor.

### BACKGROUND OF THE INVENTION

Existing bill payment systems, such as those described in U.S. Pat. Nos. 6,119,106, and 6,611,818 to Mersky et al., disclose a plurality of agent or remote computer systems at agent sites, where a customer visits and tenders payment of a bill, such as a utility bill (i.e., electric, gas, telephone etc.) or other bill (i.e., credit card, etc.) to a creditor. Customer information is entered into the agent's computer system by hand, and customer payment information is stored at the agent's site. At predetermined times during the day, the agent computer system dials or contacts a host system run by a host provider, via modem or facsimile, for example, to transfer the daily transaction information, or accumulated customer payment information between transmission times, to a host provider. The host providers' system generates a creditor report for each creditor that authorizes the host provider to accept payment on their behalf, and the host provider remits payment to the respective creditors via check, electronic fund transfer, or other agreed method, in a conventional manner. The host system then generates a closeout report based on each agent's activity, and deducts payment or receives payment from the agents' bank accounts via electronic or other conventional means in any agreed upon manner.

However, with the Mersky et al. system, payment information obtained at the agent site must wait until predetermined times of the day to be submitted to the host system, causing delay in payment and backlog at the host provider. Further, the data entry of bill information and customer information, etc., is time-consuming since each bill is uniquely laid out, and entries are made by hand into the agent computer system. Finally, payment information on each creditor is stored at the agent site, providing difficulty for the host provider to obtain historical payment information on customers.

Accordingly, a bill payment system which can read customers bills electronically, despite the different layouts of each bill, and which can forward this information immediately to the host provider for immediate payment to a creditor, is desired.

### SUMMARY OF THE INVENTION

The present invention relates to a computerized financial transaction system which, in one embodiment, encompasses payment of a bill by a customer at an agent site, where the agent accepts funds in payment of the bill, and enters or scans customer and payment information directly on a host provider's website. The host provider processes the payment information and formats the payment information into an acceptable format for electronic notification to the creditor. The host provider pays the creditor according to the creditor's protocol and debits the agent's bank account for reimbursement of the funds paid to the creditor on behalf of the customer, as well as for a service fee for the payment service.

In particular, in one embodiment consistent with the present invention, a method of performing a financial transaction using a computerized financial transaction system, includes receiving customer information into the system; scanning a bill from said customer into the system; processing said scanned bill to obtain information provided therein for paying a creditor; and inputting said information into the system.

In one embodiment consistent with the present invention, the information is obtained from the scanned bill using a zone recognition method.

In another embodiment consistent with the present invention, the method further includes storing the information on the system on at least one of an agent site and a host provider site.

In yet another embodiment consistent with the present invention, the zone recognition method includes locating predetermined fields of information on each bill; and storing the information in predetermined fields in the system.

In yet another embodiment consistent with the present invention, the zone recognition method determines which creditor is associated with the bill, and determines payment information to the creditor.

In yet another embodiment consistent with the present invention, the method further includes formatting the information into a formatted file; and sending the formatted file to one of the creditor and an authorized representative of the creditor, advising of payment of the bill by the customer.

In yet another embodiment consistent with the present invention, the method further includes running a report of all payments made on behalf of each customer.

In yet another embodiment consistent with the present invention, the computerized financial transaction system is a web-based system.

In yet another embodiment consistent with the present invention, the formatting step includes processing the information from the scanned bill for predetermined text; and removing the predetermined text to format the file.

In yet another embodiment consistent with the present invention, an apparatus for performing a financial transaction, includes, means for receiving customer information into the system; means for scanning a bill from said customer into the system; means for processing said scanned bill to obtain information provided therein for paying a creditor; and means for inputting said information into the system.

In yet another embodiment consistent with the present invention, the apparatus further includes means for storing the information on the system on at least one of an agent site and a host provider site.

In yet another embodiment consistent with the present invention, the apparatus further includes means for formatting the information into a formatted file; and means for sending the formatted file to one of the creditor and an authorized representative of the creditor, advising of payment of the bill by the customer.

In yet another embodiment consistent with the present invention, the apparatus further includes means for running a report of all payments made on behalf of each customer.

In yet another embodiment consistent with the present invention, a computer system for performing a financial transaction, includes at least one memory containing at least one program including the steps of receiving customer information into the system; scanning a bill from the customer into the system; processing the scanned bill to obtain information provided therein for paying a creditor; and inputting the information into the system; and at least one processor for running the program.

In yet another embodiment consistent with the present invention, a method of performing a financial transaction over a global computerized network, includes receiving customer information into the system; scanning a bill from the customer into the system; processing the scanned bill using a zone recognition method, to obtain information provided therein for paying a creditor; and inputting the information into a database in the system.

In yet another embodiment consistent with the present invention, an apparatus for performing a financial transaction over a global computerized network, includes means for receiving customer information into the system; means for scanning a bill from the customer into the system; means for processing the scanned bill using a zone recognition method, to obtain information provided therein for paying a creditor; and means for inputting the information into a database in the system.

In yet another embodiment consistent with the present invention, a computer system for performing a financial transaction, includes at least one memory containing at least one program including the steps of receiving customer information into the system; scanning a bill from the customer into the system; processing the scanned bill using a zone recognition method, to obtain information provided therein for paying a creditor; and inputting the information into a database in the system; at least one processor for running the program.

In yet another embodiment consistent with the present invention, a computer-readable medium whose contents cause a computer system to perform financial transactions over a network, the computer system having a program which performs the steps of receiving customer information into the system; scanning a bill from the customer into the system; processing the scanned bill to obtain information provided therein for paying a creditor; and inputting the information into the system.

In yet another embodiment consistent with the present invention, a computer-readable medium whose contents cause a computer system to perform financial transactions over a network, the computer system having a program which performs the steps of receiving customer information into the system; scanning a bill from the customer into the system; processing the scanned bill using a zone recognition method, to obtain information provided therein for paying a creditor; and inputting the information into a database in the system.

There has thus been outlined, some features consistent with the present invention in order that the detailed description thereof that follows may be better understood, and in order that the present contribution to the art may be better appreciated. There are, of course, additional features consistent with the present invention that will be described below and which will form the subject matter of the claims appended hereto.

In this respect, before explaining at least one embodiment consistent with the present invention in detail, it is to be understood that the invention is not limited in its application to the details of construction and to the arrangements of the components set forth in the following description or illustrated in the drawings. Methods and apparatuses consistent with the present invention are capable of other embodiments and of being practiced and carried out in various ways. Also, it is to be understood that the phraseology and terminology employed herein, as well as the abstract included below, are for the purpose of description and should not be regarded as limiting.

As such, those skilled in the art will appreciate that the conception upon which this disclosure is based may readily be utilized as a basis for the designing of other structures, methods and systems for carrying out the several purposes of the present invention. It is important, therefore, that the claims be regarded as including such equivalent constructions insofar as they do not depart from the spirit and scope of the methods and apparatuses consistent with the present invention.

### BRIEF DESCRIPTION OF THE DRAWINGS

FIG. 1 is a schematic of a computerized transaction processing system according to one embodiment consistent with the present invention.

### DESCRIPTION OF THE INVENTION

The present invention relates to a computerized transaction processing system for facilitating bill payment to a creditor.

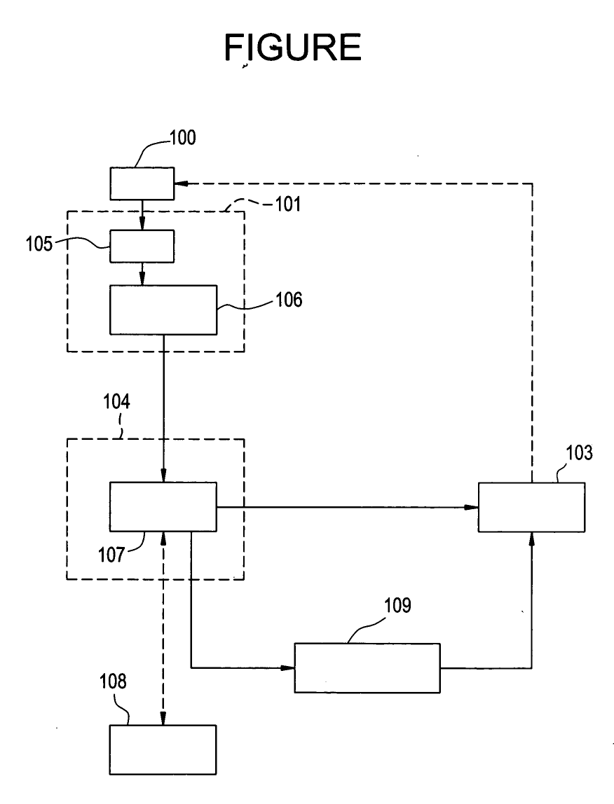

In summary, an exemplary bill system according to the present invention is shown in FIG. 1, where a customer 100 brings a bill to an agent 101 or retailer site in order to make payment on the bill to one of many creditors 103, such as a utility company (i.e., electric, gas, telephone etc.), or a credit card institution, for example. The agent 101 is in a cooperative relationship with a host provider 104 in order to accept payments on the bill for the particular creditor 103, and to have the host provider 104 pay the creditor directly on behalf of the customer.

Using the host provider's world wide web-based system, payment information for each customer 100 is entered or scanned by the agent 101 via the agent computer system 106, directly into the host provider database 107, which is located at the host provider site 104, for example.

Once the customer payment information is received by the host provider 104 for processing, the host provider 104 formats the bill payment information into an acceptable format for electronic notification to the creditor 103. In one embodiment, the creditor 103 receives the customer payment information, updates their records, and then debits the host provider's bank account for the finds paid by the customer 103. However, payment to the creditor 103 can be made in any method or format specified by the creditor 103 and pre-arranged with the host provider 104. In turn, the host provider 104 debits the agent's bank account for reimbursement of the funds paid to the creditor 103 on behalf of the customer 100, as well as for a service fee for the payment service.

The agent 101 will require a computer system 106 in order to access the host provider's website. The agent computer system 106 may include a client computer, such as a personal computer (PC), a mobile terminal, such as a mobile computing device, operated by the user accessing the program remotely from the client computer, or any other digital device that has a display screen and storage. In particular, the exemplary agent computer system 106 includes a PC with internet browser, and a DSL or higher bandwidth, and access to a server with database(s) which stores information on the customers and their bill payment history.

The PC of the exemplary agent computer system 106 typically includes a processor as a client data processing means, the processor including a central processing unit (CPU) and an input/output (I/O) interface, a memory with a program having a data structure, all connected by a bus, as well as an input device or means, a display, and may also include a secondary storage device. The bus may be internal to the client and may include an adapter to a keyboard or input device or may include external connections.

The processor at the client may be internal or external thereto, and executes a program adapted to predetermined operations. The processor has access to the memory in which may be stored at least one sequence of code instructions comprising the program and the data structure for performing predetermined operations. The memory and program may be located within the client or external thereto.

The program can include a separate program code for performing a desired operation, or may be a plurality of modules, such as those described below, performing sub-operations of an operation, or may be part of a single module of a larger program providing the operation.

The processor may be adapted to access and/or execute a plurality of programs corresponding to a plurality of operations. An operation rendered by the program may be, for example, supporting the user interface, performing e-mail applications, etc.

The data structure may include a plurality of entries, each entry including at least a first storage area that stores databases of customer information, and billing information, for example.

The storage device may store at least one data file, such as text files, data files, audio, video files, etc., in providing a particular operation. The data storage device as storage means, may for example, be a database, including a distributed database connected via a network. The storage device may be connected to a server and/or the client, either directly or through a communication network, such as a LAN or WAN. An internal storage device, or an external storage device is optional, and data may also be received via a network and directly processed.

The present invention may be carried out by providing an input means, or user selection means, including hot clickable icons etc., selection buttons, in a menu, dialog box, or a roll-down window of an interface provided at the client, and the user may input commands through a keyboard, pen, stylus, mouse, speech processing means, touch screen, or other input/selection means. The selection means may also be constituted by a dedicated piece of hardware or its functions may be executed by code instructions executed on the client processor, involving a display unit for displaying a selection window and a keyboard for entering a selection, for example.

The agent computer system 106 may be connected to other clients or servers, whether at the agent 101 or at the host provider 104, via a communication link as a communication means, using a communication end port specified by an address or a port, and the communication link may include a mobile communication link, a switched circuit communication link, or may involve a network of data processing devices such as a LAN, WAN, the Internet, or combinations thereof. The communication link may be an adapter unit capable to execute various communications protocols in order to establish and maintain communication with the server, whether at the agent 101 or host provider 104, for example. The communication link may be constituted by a specialized piece of hardware or may be realized by a general CPU executing corresponding program instructions. The communication link may be at least partially included in the processor executing corresponding program instructions.

The server, which may be located at the agent site 101 and/or the host provider site 104, may include a processor having a CPU which is a server data processing means, and an I/O interface. The processor of the server may be a general data processing unit, but preferably a data processing unit with large resources (i.e., high processing capabilities and a large memory for storing large amounts of data).

The server may include at least one memory, each with a program having a data structure all connected by a bus. The bus or similar connection line can also consist of external connections, if the server is constituted by a distributed system. The server processor may have access to a storage device for storing preferably large numbers of programs for providing various operations to the users.

The data structure may include a plurality of entries, each entry including at least a first storage area which stores information on customers and their billing history, for example, but may also have alternative embodiments including that associated with other stored information as one of ordinary skill in the art would appreciate.

The server may be a single unit or may be a distributed system of a plurality of servers or data processing units, and may be shared by multiple users in direct or indirect connection to each other. The server performs at least one server program for a desired operation, which is required in serving a request from the agent computer system 106.

In another embodiment consistent with the present invention, the server may also be used in a distributed environment, and may include a distributed CPU including a plurality of individual processors on one or a plurality of machines. Finally, the present system may be a distributed system with only a plurality of client computers connected together over a network.

In operation, in one embodiment consistent with the present invention, the customer 100 would either in person or by mail, present a bill from a utility company 103, for example, to an agent at the agent site 101, along with the customer's payment. The agent/user would then log onto the agent computer system 106, and in one embodiment, accesses the Internet to locate the host provider's website. However, one of ordinary skill in the art would be aware that the agent computer system 106 may not use a world wide web-based system, but may be a LAN, WAN, or other system, or directly connected to the host provider computer system 107 via modem etc.

Once at the host provider website, or when connected to the host provider computer system 107, the agent/user must enter a login name and password in order to be able to utilize the bill payment system of the present invention. If login is not successful, the agent/user at the agent site 101 may not gain access to the host provider system 107.

In another embodiment consistent with the present invention, a timer can be pre-set at the host computer system 107, such that if the agent/user user does not log in within a pre-set period of time, the session with the host provider system 104 is terminated.

The host provider system 107 will have pre-set security levels set for each agent/user, including security scope, such as the amount of information a specific agent/user is able to access/modify.

Once login is successful, and the agent/user is logged into the host provider system 107, the agent/user would enter personal information into a customer screen related to the customer 100, such as name, address, city, state, zip code, phone number, social security number and e-mail address, and the type of transaction, such as bill type, account number, phone number or zip code, charge amount, service fee amount, subtotal, and global batch transaction total, for example. If the customer 100 is already known to the agent/user, then a customer ID is all that is required to be entered to pull up personal information on the customer 100.

Information that is stored at the agent 101 or the host provider 104, would include information specific to the particular agent site (i.e., location, service fee, type of scanner), individual customer transactions (i.e., customer, bill type, amount), agent/user information (i.e., login, security level), and security level information (i.e., administrator, manager, user). The computer system also stores a batch ID which relates to transactions and batch ID and transaction ID for each relationship.

To initiate a transaction from the customer screen, the agent/user must enter a predetermined required amount of information on the creditor's bill which is to be paid. In particular, the agent/user must enter information such as the account number from the creditor's bill, the customer name, phone number, and perhaps the city name, and zip code. If the customer 100 has an ID number, that can be used also. The agent/user would also enter an amount, in U.S. dollars or other currency, that the customer 100 wishes to pay on any particular bill. Multiple transactions can be entered at the same time by the agent/user for a single customer 100.

The program of the present invention will then prompt the agent/user to insert the bill into a scanner, and to scan the bill. The scanner 105 may be conventional, such as a Magtek MicrImage RS232 scanner, which reads data from the scanned image using optical character recognition (OCR), which is a process which produces a page of digital text from printed material scanned into a memory of a client computer such as the agent computer system 106.

In one embodiment consistent with the present invention, when the agent/user enters the creditor information into the system, the program will automatically match the creditor information to a particular creditor bill type (i.e., layout). Thus, the scanner 105 will scan into the system, and the program will access the database (i.e., on the server of the host provider computer system 107), to process the scanned image in memory to locate the information from the bill according to a “zone recognition method”. In the “zone recognition method”, predetermined fields of information are located on each creditor bill type and stored. Thus, the program would process the scanned image in memory, in a predetermined manner, using predetermined coordinates for each unique creditor bill, to locate and read at predetermined zones, the creditor name, creditor location, customer name, address and phone number, customer account number, and the amount to be paid by the customer 100, and other information specified on the creditor bill. Thus, each type of creditor bill which is received at the agent site 101 has its information automatically scanned into the agent computer system 106, read by the program, and then stored in a database located, for example, at a server at the host provider computer system 107.

In an alternative embodiment, the input of the creditor information does not automatically trigger the zone recognition method to read the bill according to a predetermined bill layout which is stored in memory. Rather, the program may process the predetermined fields of information using OCR etc., to obtain the necessary information from those fields to store into memory at the server, or the location of these fields may match a predetermined bill type and creditor 103 when compared by the program with a database of bill types, and the necessary fields may be located and read into memory by the program.

Of course, manual input by the agent/user of the customer information etc., can also be performed.

The bills are scanned in the order processed by the agent/user. No agent/user input aside from inserting the bill into the scanner, is necessary. Once scanning is completed, the agent/user will be returned by the program to the “main” screen where a new transaction can be performed.

The program allows the host provider 104 to modify the creditor bill type to ensure that any modifications to the bill are taken into account, and all the appropriate zones are read and processed by the program.

In another embodiment consistent with the present invention, access by the agents/users can be modified and/or searched, as well as the names/locations of the agents, creditor bill type, and customers, for example. Transactions can be searched and voided by the agent/user, and in one embodiment, voided only if the transaction was added prior to midnight of that day. If not modified that day, the agent/user would make a modification to the system on the next day.

Once the information is entered or scanned into the agent computer system 106, the agent/user can accept payment from the customer in the form of check, cash, or credit card etc. Although cash is the routine method of payment by the customer 100, checks and credit cards may also be used (i.e., in the event the customer wishes to write one check for several bills, or the creditor 103 does not provide for payment by credit card with their bill statement), with an additional fee. In that case, check or credit card authorization may be performed at the agent site 101, in a conventional manner, by using a third party authorization system 108, for example, before being accepted as payment. However, check and credit card authorization can also be performed at the host provider 104 using a third party authorization system 108 with an additional fee.

Once the agent/user has completed the payment transaction with the customer 100, the agent/user can exit the host provider website, and print a payment receipt for the customer 100.

The payments made during the day by the customers on their bills, are deposited at predetermined times by the agent 101 into the agent's bank account.

In another embodiment consistent with the present invention, the host provider 104 does not use a web-based system, and the agent 101 must scan and enter the information directly into memory at the agent computer system 106, and then send the customer file from the agent computer system 106 to the host provider computer system 107 after each transaction, using a modem etc. The file from the agent computer system 106 is sent for processing to the host provider computer system 107 via file transfer protocol (FTP).

In this embodiment, the agent computer system 106 may store the specific information on each customer (i.e., name, address, phone), rather than, or in addition to, at the host provider computer system 107.

Once the bill payment information is either sent to the host provider 104 by modem, or inputted to the host provider computer system 107 using the host provider website, the information or data from the agent 101 on the customer 100 and the bill payment information, is processed at the host provider 104 prior to payment.

The host provider 104, in one embodiment consistent with the present invention, processes the customer payments at a predetermined time each day, but one of ordinary skill in the art would know that processing could be programmed to take place at various times in the day.

As stated previously, if the agent 101 does not obtain credit card or check authorization via a third party authorization service 108, then the host provider 104 can perform this function for an additional fee. If the customer's bank account has insufficient funds, or credit is denied by the third party authorization service 108, then the host provider 104 will notify the agent 101, and processing of the customer's payment to the creditor 103 is halted.

The host provider computer system 107 can be programmed to process the accumulated information on the customer payments at least once per day, by providing a printout or a file, separated by creditor, for formatting prior to payment. The program automatically formats each field of the file received from the agent 101 on each bill, including the currency values, phone numbers, zip codes, and dates, to remove parentheses etc. E-mails are also verified prior to proceeding. The program formats the information in each file into a format which can be transferred to, and accepted by the creditor 103, and also which can be sent using ACH to the creditor bank 109.

Once formatted by the program, the files, which are separated by creditor 103, are electronically transferred to each creditor company 103 or party authorized to accept payment on behalf of the creditor 103, in accordance with the creditor's protocol and prior agreement with the host provider 104. In one embodiment consistent with the present invention, the files are transferred to the creditor 103, referencing the customer's account, and stating that the bill has been paid. In addition, the money in payment on each creditor's bill is paid to the creditor bank or financial institution 109 by ACH bank transfer from the host provider's bank. The creditor's bank 109 will then inform the creditor 103 that payment has been made for that customer 100. The creditor 103 will then update their records with the payment information and inform the customer 100 on their next bill statement.

Alternatively, the creditor 103 can be informed by electronic file transfer that the customer bill has been paid, and the creditor 103 can automatically debit the host provider bank account for the funds.

After payment has been made to the creditor 103 on behalf of the customer 100, the host provider 104 then debits the agent's bank account for the funds paid to the creditor 103, including the predetermined service fee agreed upon between the agent 101 and the host provider 103.

If desired, the agent 101 or the host provider 104 can run a report of all payments, at any time, made on behalf of each customer 100, by creditor 103, agent 101, etc.

It should be emphasized that the above-described embodiments of the invention are merely possible examples of implementations set forth for a clear understanding of the principles of the invention. Variations and modifications may be made to the above-described embodiments of the invention without departing from the spirit and principles of the invention. All such modifications and variations are intended to be included herein within the scope of the invention and protected by the following claims.

1. A method of performing a financial transaction using a computerized financial transaction system, comprising:
receiving customer information into the system;
scanning a bill from said customer into the system;
processing said scanned bill to obtain information provided therein for paying a creditor; and
inputting said information into the system.

2. The method according to claim 1, wherein said information is obtained from said scanned bill using a zone recognition method.

3. The method according to claim 1, further comprising:
storing said information on the system on at least one of an agent site and a host provider site.

4. The method according to claim 2, wherein said scanning step is performed using optical character recognition.

5. The method according to claim 2, wherein said zone recognition method comprises:
locating predetermined fields of information on each said bill; and
storing said information in said predetermined fields in the system.

6. The method according to claim 2, wherein said zone recognition method determines which creditor is associated with said bill, and determines payment information to said creditor.

7. The method according to claim 5, further comprising:
formatting said information into a formatted file; and
sending said formatted file to one of said creditor and an authorized representative of said creditor, advising of payment of said bill by said customer.

8. The method according to claim 7, wherein said formatting step takes place at at least one predetermined time each day.

9. The method according to claim 1, further comprising:
obtaining authorization from a third party that said customer has sufficient funds for payment of said bill.

10. The method according to claim 7, further comprising:
running a report of all payments made on behalf of each said customer.

11. The method according to claim 1, wherein said computerized financial transaction system is a web-based system.

12. The method according to claim 7, wherein said formatting step comprises:
processing said information from said scanned bill for predetermined text; and
removing said predetermined text to format said file.

13. An apparatus for performing a financial transaction, comprising:
means for receiving customer information into the system;
means for scanning a bill from said customer into the system;
means for processing said scanned bill to obtain information provided therein for paying a creditor; and
means for inputting said information into the system.

14. The apparatus according to claim 13, further comprising:
means for storing said information on the system on at least one of an agent site and a host provider site.

15. The apparatus according to claim 13, further comprising:
means for formatting said information into a formatted file; and
means for sending said formatted file to one of said creditor and an authorized representative of said creditor, advising of payment of said bill by said customer.

16. The apparatus according to claim 13, further comprising:
means for obtaining authorization from a third party that said customer has sufficient funds for payment of said bill.

17. The apparatus according to claim 13, further comprising:
means for running a report of all payments made on behalf of each said customer.

18. A computer system for performing a financial transaction, comprising:
at least one memory containing at least one program comprising the steps of:
receiving customer information into the system;
scanning a bill from said customer into the system;
processing said scanned bill to obtain information provided therein for paying a creditor; and
inputting said information into the system; and
at least one processor for running the program.

19. A method of performing a financial transaction over a global computerized network, comprising:
receiving customer information into the system;
scanning a bill from said customer into the system;
processing said scanned bill using a zone recognition method, to obtain information provided therein for paying a creditor; and
inputting said information into a database in the system.

20. The method according to claim 19, further comprising:
forwarding payment information to one of a creditor and an authorized representative of said creditor, of payment of said bill.

21. The method according to claim 19, wherein said receiving step is performed at an agent site.

22. The method according to claim 19, wherein said scanning step is performed at an agent site.

23. The method according to claim 19, wherein said zone recognition method comprises:
locating predetermined fields of information on each said bill; and
storing said information in said predetermined fields in said database of the system.

24. The method according to claim 20, wherein said forwarding step takes place at a host provider site.

25. The method according to claim 19, wherein said zone recognition method determines which creditor is associated with said bill, and determines payment information to said creditor.

26. The method according to claim 20, further comprising:
formatting said information into a formatted file; and
sending said formatted file to one of said creditor and an authorized representative of said creditor, advising of payment of said bill by said customer.

27. The method according to claim 26, wherein said formatting step comprises:
reviewing said payment information for predetermined text; and
removing said predetermined text to format said file.

28. An apparatus for performing a financial transaction over a global computerized network, comprising:
means for receiving customer information into the system;
means for scanning a bill from said customer into the system;
means for processing said scanned bill using a zone recognition method, to obtain information provided therein for paying a creditor; and
means for inputting said information into a database in the system.

29. The apparatus according to claim 28, further comprising:
means for formatting said information into a formatted file; and
means for sending said formatted file to one of said creditor and an authorized representative of said creditor, advising of payment of said bill by said customer.

30. A computer system for performing a financial transaction, comprising:
at least one memory containing at least one program comprising the steps of:
receiving customer information into the system;
scanning a bill from said customer into the system;
processing said scanned bill using a zone recognition method, to obtain information provided therein for paying a creditor; and
inputting said information into a database in the system;
at least one processor for running the program.

31. A computer-readable medium whose contents cause a computer system to perform financial transactions over a network, the computer system having a program which performs the steps of:
receiving customer information into the system;
scanning a bill from said customer into the system;
processing said scanned bill to obtain information provided therein for paying a creditor; and
inputting said information into the system.

32. A computer-readable medium whose contents cause a computer system to perform financial transactions over a network, the computer system having a program which performs the steps of:
receiving customer information into the system;
scanning a bill from said customer into the system;
processing said scanned bill using a zone recognition method, to obtain information provided therein for paying a creditor; and
inputting said information into a database in the system.
